(19) United States
(12) Patent Application Publication
(10) Pub. No.: US 2008/0005319 A1
(43) Pub. Date: Jan. 3, 2008

(54) MONITORING COMPUTER USE THROUGH A CALENDAR INTERFACE

(76) Inventors: Eric J. Anderholm, Holmen, WI (US); David R. Losen, La Crosse, WI (US); Robert A. Abbe, Chaska, MN (US)

Correspondence Address: STRATEGIC PATENTS P.C.., C/O PORTFOLIOIP, P.O. BOX 52050, MINNEAPOLIS, MN, 55402, US

(21) Appl. No.: 11/748,232

(22) Filed: May 14, 2007

Related U.S. Application Data
(60) Provisional application No. 60/747,370, filed on May 16, 2006.

(51) Int. Cl. G06F 15/173; G06F 3/00; H04L 9/32

(52) U.S. Cl. 709/224; 715/700; 726/26

(57) ABSTRACT

In embodiments of the present invention improved capabilities are described for a method and system of monitoring a computer device including indicating on a computer device configuration settings used to monitor a user interaction, the configurations settings being saved on a storage device; comparing the user interaction to the configuration settings; identifying conflicts between the user interaction and the configuration settings, the conflicts being saved to a storage device; and displaying to a calendar style graphic user interface (GUI) at least one conflict.

### CROSS-REFERENCE TO RELATED APPLICATIONS

This application claims the benefit of the following provisional application, which is hereby incorporated by reference in its entirety:

U.S. Provisional Application 60/747,370, filed May 16, 2006.

### BACKGROUND

1. Field

This invention relates to methods and systems for computer security, and more specifically, to the area of monitoring computer usage and controlling computer usage based on specific criteria such as time, application use, and other pre-defined user criteria.

2. Description of Related Art

Monitoring and controlling computer usage, particularly in the home and business, fulfills a critical security need that is equally important as many of our conventional notions of security applied to tangible property and personal safety. The home or business computer is often a repository for critical personal data and financial data. It is therefore desirable that primary users such as parents or businesses who authorize use of their computers by third parties such as children or employees be able to monitor proper usage to ensure that such data is not being misused, improperly accessed, transmitted, or otherwise made the object of inappropriate activity.

Monitoring and control of computer usage also fulfills a critical need related to parenting and employee supervision. Via the Internet, the home or business computer becomes a central hub for communication with the outside world. Individuals may use home or business computers to access a wide array of information and images from the Internet, log on to various games and activities via the Internet, communicate with both known and unknown third party users in other locations via chat rooms, instant messaging, and e-mail, and engage in other activities about which a parent or supervisor may wish to have more information. A need exists for methods and systems that allow parents and supervisors an improved ability to monitor computer use and restrict inappropriate interactions with computers, particularly interactions with external cyberspace.

### SUMMARY

A method and system disclosed herein may include indicating on a computer device configuration settings used to monitor a user interaction. The configuration settings may be saved on a storage device. The methods and systems may optionally further include one or more of comparing the user interaction to the configuration settings; identifying conflicts between the user interaction and the configuration settings; saving the conflicts to a storage device; and displaying to a graphic user interface (GUI), an indicator of at least one conflict, such as from a stored set of conflicts.

The method and system of monitoring a computer device may further include emailing a report of inappropriate activity.

The computer device may be any kind of computer, such as, but not limited to, a desktop computer, a laptop computer, a handheld computer, a smart phone, a server, a web server, a PDA, or the like. A user may access any computer device for the user interactions.

The GUI may be accessed on an individual computer device. The GUI may be accessed from a server over a computer network. The computer network may involve a wired connection, a wireless connection, an IR connection or other kind of network, including local area networks, wide area networks, the Internet or other network.

The configuration settings may define a user-inappropriate interaction. The defined inappropriate interaction may be of various types, such as interaction with any third party, cyberstalking, pornography, non-business use of a computer device, viewing a prohibited website, computer hacking, searching for personal information, spreading a virus, or the like.

The configuration settings may be to set program time limits. The configuration settings may set an email option where the email option may be the address of the email, the content of the email, the subject of the email, or the like. The configuration settings may set instant message options where the instant message option may be the address of the instant message, the content of the instant message, or the like. The configuration settings may be used to display a flash screen for inappropriate behavior where the flash screen may be over a visible application window, supplants a visible application window, or the like. The configuration settings may block a software application from executing. A user may enter the configuration settings. The configuration settings may be downloaded from a network. The network may be selected from a list including the Internet, a WAN, a LAN, a peer-to-peer network, an intranet, and the like. A second downloaded configuration setting may replace a first downloaded configuration setting. A user may override a downloaded configuration setting. The configuration settings may be a combination of user entered settings and downloaded settings.

A user interaction may be selected from a group including, but not limited to, running a software application, sending an email, sending an instant message, browsing a network, browsing the internet, browsing a web page, playing a computer game, filling out a form, entering into a transaction, submitting a name, submitting personal information, downloading a file, downloading a particular type of file (e.g., from a file-sharing network, such as a peer-to-peer network) and the like.

The storage device may any kind of physical data storage facility, such as, but not limited to a hard drive, a CD drive, a DVD drive, a floppy drive, a zip drive, a flash memory, random access memory (e.g., RAM, DRAM, SRAM or other types of RAM), a jump drive, and the like.

A “file” should be understood to include any file, as well as any other kind of data storage facility, such as, but not limited to, a collection of multiple files (stored in a hierarchy, stored without a hierarchy, stored in one location, or stored in separate locations), a database, an SQL database, a relational database, a table, an ASCII table, a flat file stored to the storage device, and the like. A file may store the user conflict interactions. The file may store the programs to be excluded from being blocked from execution. The file may store the programs to be blocked from execution, websites to be excluded from browsing, or the like. The file may store web pages to be excluded from browsing. The file may store criteria for downloadable files that are excluded from being downloaded. The file may store criteria for downloadable programs that are excluded from being downloaded, inappropriate content to be checked, or the like. The inappropriate content may be, without limitation, a word, a phrase, an abbreviation, a lingo term, or the like. The lingo term may be an instant messenger abbreviation. The file may store the amount of time a computer device is used. The file may store the amount of time a software application is to execute. The file may store the type of web browser that is executed. The file may be a main system file. The main system file may store information such as user information, computer device information, window names, URLs, mouse action, keyboard action, program Ids, executed program name, and the like.

The time period may be an hour, a day, a week, a month, a fiscal quarter, a calendar quarter, a fiscal year, a calendar year, and the like. The time period may be user defined. The time period may be presented as a calendar.

The GUI may include a display of statistics for a particular computer device. The GUI may include a display of inappropriate interactions per the selected time period. The selected time period may be presented as a calendar. The calendar may include time periods such as an hour, a day, a week, a month, a fiscal quarter, a calendar quarter, a fiscal year, a calendar year, and the like. The selected time period may be user defined. The inappropriate interactions may be aggregated for a particular computer device, a networked computer device, the calendar time periods, the computer device, inappropriate interactions, or the like.

The GUI may include a display of computer device configuration settings.

The computer device may be blocked from executing a software application, operating after a certain amount of time, executing a particular web browser, using configuration defined content, operating after a certain amount of time, and the like.

Identifying the conflict may further include instantaneous feedback. The instantaneous feedback may include, for example, a banner placed over a visible application window. The instantaneous feedback may include an audio indication. The instantaneous feedback may include blocking an execution of a software application. The instantaneous feedback may include blocking a browsing of a website. The instantaneous feedback may include the blocking a browsing of a webpage. The instantaneous feedback may include locking an operation of the computer device. The instantaneous feedback may include setting a time limit for a software application execution. The instantaneous feedback may be saved for each inappropriate interaction. The instantaneous feedback may be stored in a feedback file. The feedback file may be any of the types described above.

A report may be generated from the stored set of conflicts. The report may be a user-defined custom report. The report may be in a calendar format. The calendar may include time periods such as an hour, a day, a week, a month, a fiscal quarter, a calendar quarter, a fiscal year, a calendar year, and the like. The report may be a result of data mining of the stored conflicting interaction statistics, may be searchable, may cover a time period, may consist of a summary, and may include statistical data, temporal information, frequency information, filtered information, or the like. The time period may be an hour, a day, a week, a month, a fiscal quarter, a calendar quarter, a fiscal year, a calendar year, and the like.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF FIGURES

The invention and the following detailed description of certain embodiments thereof may be understood by reference to the following figures:

FIG. 1 illustrates an embodiment of the graphical user interface, shown as the main screen of a calendar style user interface.

FIG. 2 illustrates an embodiment of the graphical user interface that may appear when a user selects any of the icons that appear on a particular time period in the calendar interface.

FIG. 3 illustrates an embodiment of the graphical user interface that may appear when a user selects the Advanced Setup Options button, where in this instance the Data Settings screen is shown.

FIG. 4 illustrates an embodiment of the graphical user interface that appears when a user selects the Application Settings button within the advanced setup options.

FIG. 5 illustrates an embodiment of the graphical user interface that appears when a user selects the Time Limit button under the Application Settings screen within the advanced setup options.

FIG. 6 illustrates an embodiment of the graphical user interface that appears when a user selects the E-mail Settings button within the advanced setup options.

FIG. 7 illustrates an embodiment of the graphical user interface that appears when a user selects the Inappropriate Words button within the advanced setup options.

FIG. 8 illustrates an embodiment of the graphical user interface that appears when a user selects the Inappropriate Websites button within the advanced setup options.

FIG. 9 illustrates an embodiment of the monitoring application file layouts.

FIG. 10 is a schematic and flow diagram showing the steps used for identifying programs for blocking.

FIG. 11 is a schematic and flow diagram showing the steps used for blocking programs.

FIG. 12 illustrates an embodiment of the blocked graphic which appears when a third party tries to access a program that has been blocked according to user instruction or criteria.

While the invention has been described in connection with certain preferred embodiments, other embodiments would be understood by one of ordinary skill in the art and are encompassed herein.

All documents referenced herein are hereby incorporated by reference.

### DETAILED DESCRIPTION

Disclosed herein are systems and methods that may provide comprehensive monitoring and control features for a designated computer device through a calendar style interface that optionally serves as both a control center and a data center. The monitoring and control features may allow a user to monitor and control the functions performed on the designated computer device and any interactions with external data sources that take place by means of the designated computer device. With more particularity, the monitoring and control features may be directed to the detection and restriction of those functions and interactions on the designated computer device that the user considers undesirable or inappropriate.

In embodiments, the calendar style interface may provide the user with summaries or summary icons reflecting activities involving the designated computer device along with configuration and user control settings whereby the user monitors and controls the designated computer. Through the data center displayed on the calendar interface, the user may be able to access the specific details underlying the data summaries or summary icons displayed on the interface, so that the user may obtain more information about any designated computer activity or interaction identified during the monitoring process. Access to the underlying details may be provided in a user-friendly way, for example by click-through capabilities or other graphic or text selection. Through the control center displayed on the calendar interface, the user may be able to track activities or interactions involving a designated computer device and/or interfere with undesirable activities performed on the designated computer device or undesirable interactions that take place via the designated computer device.

For example, these systems and methods may provide a method of blocking applications on a designated computer device while concurrently preserving a record of attempts to access prohibited programs. In another aspect, these systems and methods may provide the ability to block or time limit use of selected applications, while selectively excluding certain programs from such restrictions.

Tracking capabilities may include the ability to track use of a specified program, interaction with websites (using both URL and content tracking), and interactions that use “slang” or lingo tracking, such as in instant messaging (IM) communications. The monitoring application may translate the “slang” or lingo of instant IM communications by providing a translation of an IM dialogue into standard language syntax to make the IM dialogue meaning clear. These systems and methods may permit the detection of inappropriate content within a software application or communication. In addition to logging such activity, these systems and methods may permit creating pre-defined actions that may, for example, block the offending software applications or communication, issue a warning, post a banner, or engage in some other specified restrictive or regulating action.

The user may be any person responsible for or having control over the designated computer device (e.g. a parent, business owner, supervisor, manager, network administrator, security personnel, IT manager, or the like). The user may be responsible for determining which computer-based functions and interactions are inappropriate, undesirable, unsuitable, etc., or the user may be the agent of the person or entity who makes such determinations. The user may be the employee, for example the network administrator or IT manager, of a corporate entity whose policies would limit access of company employees to websites with offensive, sexual, or work-unrelated content, or whose policies would prohibit the use of non-work-related programs during working hours. The systems and methods disclosed herein may be used to monitor and control such inappropriate content or functionality. The monitoring and control functions provided by these systems and methods may be exercised on a company's behalf by an individual user or by a group of users, for example, an IT staff, that has responsibility for the company's individual computer devices and/or network. A particular user may have global access to monitoring and control functions, or may have only selected access. For example, one user may be able to monitor a designated computer's access to inappropriate websites, while another user, perhaps a supervisor, must approve any interdiction of content or program functions. Functions and interactions involving the designated computer device may be carried out by individuals regularly permitted to access the designated computer device (e.g. a child or employee), or by those with temporary access (e.g. visitor or business client). The functions and interactions involving the designated computer device may also include those performed by an unauthorized individual or entity.

The computer device may be any kind of computer, such as a desktop computer, a laptop computer, a handheld computer, a PDA, a smart phone, a server, a web server, other computer device, or computer network. The graphical user interface (GUI) may be accessed on an individual computer device or from a server over a computer network. The computer network may be wired, wireless, IR, or the like, and may be a local area network, wide area network, Internet, VPN, telecommunications network, hybrid network, or other kind of network.

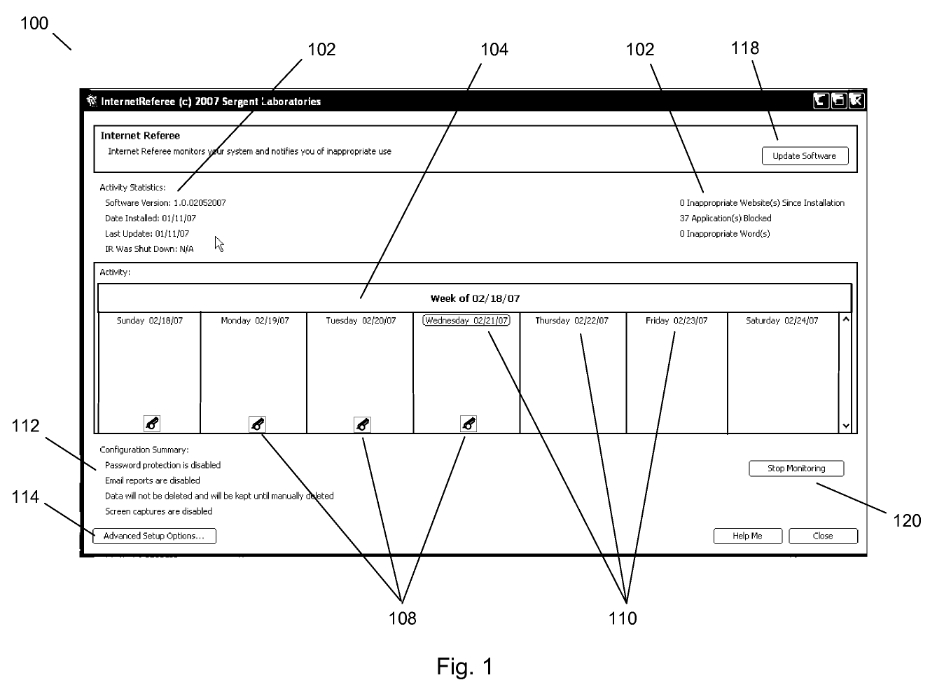

Referring to FIG. 1, an embodiment of a GUI demonstrating the calendar style interface is shown. The GUI may allow a user to access a set of configurations for monitoring usage and controlling software application access, the GUI may also contain the main calendar style interface with summary user statistics and click-through icons that trigger various functions in response to user interaction with them, such as mouse clicks, mouse-over events, and the like.

When the user navigates to the main or home screen 100 illustrated in FIG. 1, the user may be presented with activity statistics 102 which may be a summary form of the computer device interaction data compiled and stored in a main system table, described in further detail herein.

The activity statistics 102 may include a wide range of information relevant to characterizing the activities of the monitored computer assets, such as software application type and version, a date the monitoring application was installed, a monitoring application's last update, a date the monitoring application was shut down, a number of inappropriate websites accessed since installation, a number of instant messenger buddies that may have been added since the monitoring application was installed, a number of applications that may have been blocked, and other such statistical information data fields.

In an embodiment, a monitoring application software version field may provide a visual or graphic icon to the user of the original or new versions of the applications that may have been installed either by a download, automatic download, user installation, or the like. In an embodiment, a new version may have a different alphanumeric identification than a previous version of the monitoring application, and clicking on the Update Software 118 button may provide updates to the software.

In an embodiment, an installation date field showing when the monitoring application was installed may be an indication of a date of the original application installation or a date of an installation update. In an embodiment, the monitoring application install date may be the date of the application software version indicated in the monitoring application software field.

In an embodiment, a last updated field may contain a date of the last monitoring application software update. In an embodiment, the date of the last monitoring application software may be the date of the application software version indicated in the monitoring application software field.

In an embodiment, a shutdown date field may provide the date the last time the monitoring application may have been shutdown or deactivated. This information may be of interest to the user to identify a date upon which the monitoring software was deactivated. This date may allow the user to further investigate the monitoring application shutdown in further detail.

In an embodiment, a number of inappropriate websites accessed field may track the total number of inappropriate website interactions since the installation of the monitoring application software. In another embodiment, the number of inappropriate website interactions may be in relation to the last application update or another time period. In embodiments, the date for access of an inappropriate website may be provided.

In an embodiment, a field may show the number of instant message buddies since installation. The field may be the total number of new instant message buddies added since the original monitoring application software installation, the total number of instant messenger buddies added since the last monitoring application update, or the number of instant messenger buddies added during another time frame. In embodiments, the names of the instant messenger buddies may be provided.

In an embodiment, a number of applications blocked field may indicate the total number of applications blocked since the original monitoring application software installation, the total number of applications blocked since the last monitoring application update, or the number of applications blocked during another time frame. In embodiments, the names of the blocked applications may be provided.

In an embodiment, there may be additional monitoring or statistical data fields that may be presented in the activity statistics section 102. In an embodiment, the user may be able to select the data fields or indicators to display in this section. It should be understood that the fields described herein may include fields, lines, tables, icons, graphics, text elements, forms, bars, charts, or other representations of quantitative or qualitative data.

The user may view recent computer device interaction data aggregated in the calendar interface 104 portion of the main screen 100. In an embodiment, the calendar interface 104 may include a number of cells showing time periods to be monitored. For example, the calendar interface 104 may be organized in week format with each cell being a day of the week. In an embodiment, the cell of the calendar interface may show information relevant to monitoring of the computer device during the applicable time period.

In an embodiment, each cell of the calendar interface 104 may display an icon 108, the color of which icon 108 may indicate whether there has been an inappropriate computer device interaction during the time period of the cell. The icon 108 may be colored to indicate inappropriate use (e.g. red) that has been detected during that time period. In an embodiment, there may be a plurality of different colors used to indicate the type of interaction that has taken place on the designated computer device. In an embodiment, the cell may also have a time, date, and summary data link 110 that may appear in the same cell for the time period. The user may click on the link 110 for a more detailed view of the inappropriate interaction information.

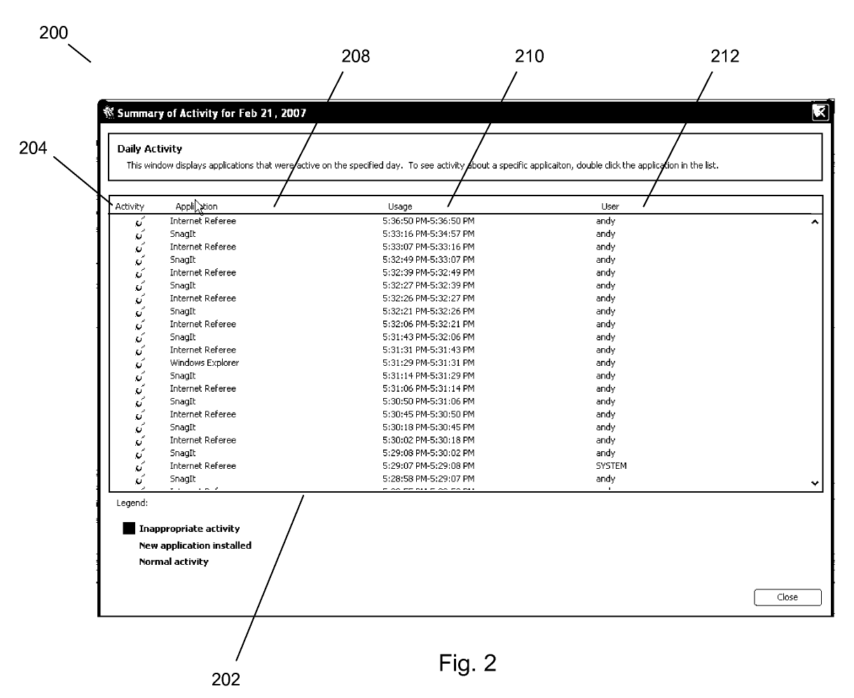

In an embodiment, if there was no inappropriate action during that time period, the more detailed information may appear in a pop-up screen as shown in FIG. 2. In an embodiment, the pop-up screen may contain a record of the software applications used and corresponding information in historical form. In an embodiment, if there was inappropriate interaction, the more detailed information may appear in a pop-up screen shown in FIG. 2, and there may be a record of the inappropriate interaction aggregated in accordance with user criteria contained in the configuration data tables.

In an embodiment, the calendar interface 104 may provide the user with an overall view of the computer device activities for the displayed time periods. In an embodiment, the user may be able to determine the time period to be displayed and the number of time periods to display. For example, the user may wish to view the week's activities by performing a computer device review on a Friday that displays the entire week's cells. In an embodiment, as the number of displayed cells increases and detailed cell information may be difficult to display in the small cell (e.g. a month is displayed), the cell representing the larger time period may assume a color indicating an interdicted computer device behavior, so that the user will know to investigate the individual cells further.

In an embodiment, there may be scroll bars on the calendar interface 104 that may allow a user to scroll through the calendar time periods.

In an embodiment, there may be a button to provide a quick report, full report, custom report, or other type of report of the displayed cells, a selected number of cells, or any cells of the user's determination.

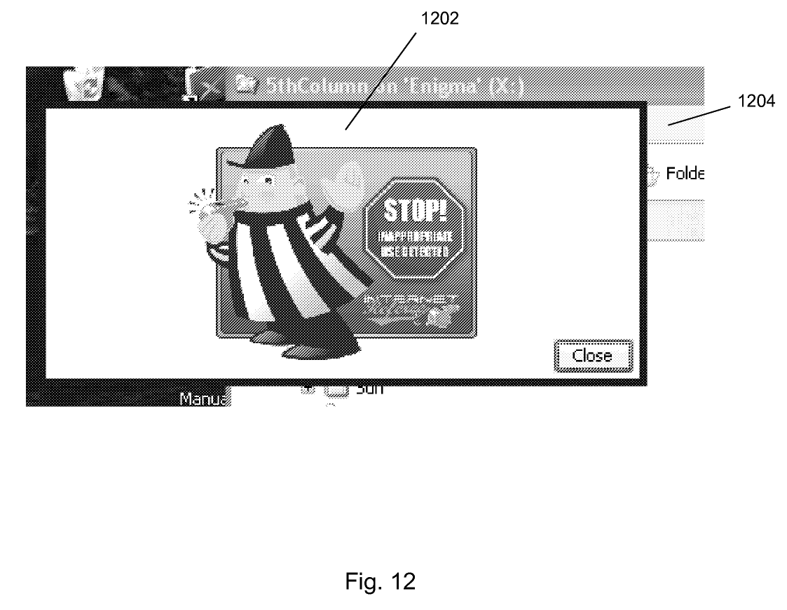

Additionally, the user may be alerted to a blocked software application before the user accesses the main screen and calendar interface. If the monitoring application is active on a designated computer device, the device screen may show a blocked version of the program upon login, as shown in FIG. 12. In an embodiment, clicking on the Stop Monitoring 120 button may stop monitoring.

Continuing to refer to FIG. 1, at the bottom of the main screen 100 the user status settings 112 may show how the ‘Advanced Settings’ have been configured to control the interactions of the designated computer device. In an embodiment, the user may set preferences for computer device control and monitoring through the Advanced Setup Options 114. The use of Advanced Setup Options 114 may allow the user to actively review the computer device interaction and blockage data while adjusting the configuration settings in an interactive manner. For example, the user may view a set of calendar cells and may see inappropriate interaction activities for the computer device. While viewing the cells with the information, the user may be able to modify the configuration settings to better monitor the computer device interactions.

In an embodiment, configuration settings may include check boxes, radio buttons, or the like for setting configurations of the monitoring application. The configuration settings may include a flash screen display setting, a setting to block applications if there is inappropriate, a setting to an enable program time limits, an email report of inappropriate activity setting, an enable password protection setting, a monitoring application disable setting, or the like. The monitoring application disable setting may also have associated indicators for the amount of time the application may be disabled and an action to take when the amount of disable time is complete.

In an embodiment, the flash screen display if inappropriate behavior setting may indicate to the monitoring application that a flash screen banner or message has been displayed over a visible window because the window has an inappropriate interaction. In an embodiment, the display of the flash screen over the visible window may prevent other interaction with that visible window. In an embodiment, there may be a different flash screen for different inappropriate interactions. For example, there may be one flash screen for an inappropriate application and another flash screen for an inappropriate website.

In an embodiment, a block application if inappropriate use setting may indicate that a software application running on the computer device is an inappropriate application that may be blocked from execution. In an embodiment, a user attempting to use a blocked application may receive a message, flash screen, or other indication that the application is blocked from use on a particular computer device. In an embodiment, different computer devices may have different applications blocked from executing. For example, a designated computer device may have certain known music download software programs blocked, or certain game applications blocked. In an embodiment, when selecting this setting the user may be able to define the software applications that are inappropriate. There may be a plurality of user defined inappropriate applications. In the alternative, there may be a “block all except” setting that permits only certain programs to run (e.g., word processing or spreadsheet programs), while all others are blocked.

In an embodiment, a enable program time limits setting may allow the user to set time limits for certain software applications on the computer device. In an embodiment, when the user selects this configuration setting the user may be able to indicate the software application to limit and the amount of time for the limit. A parent, for example, may not wish to block all instant messaging by the child, but may wish to limit the child's time spent in such communications. In an embodiment, the user may be able to indicate a plurality of software applications to limit the time of use.

In an embodiment, a email report of inappropriate activity setting may allow the user to specify an email address to which information would be sent regarding a designated computer device's inappropriate interactions. With this setting, the computer device may automatically send an alert, message, note, or other description of the inappropriate interaction to a selected email address. In an embodiment, the user may be able to write the alert, message, note or other description that is sent in the email or there may be a standard email alert, message, note, or other description. The user may be able to set a different email report for a plurality of inappropriate interactions. For example, the user may be able to send different email reports for inappropriate websites, email, instant messaging, application use, and the like. In an embodiment, this configuration setting may allow the user to monitor many different computer devices in real time and depending on the email report the user may be able to take action within a timely manner. A network administrator may be able to document that an employee is accessing inappropriate websites from the office computer, for example, and police such behavior in real time. In an embodiment, a user or third party using the computer in an inappropriate way may be unaware of the alert email being sent.

In an embodiment, an enable password protection setting may allow the user to set a password to the monitoring application. In an embodiment, if the user selects this setting, the user may be prompted to input and/or verify a password for the monitoring application. In an embodiment, the password may be used to prevent another individual from changing or interfering with any of the reporting and configuration settings of the monitoring application.

In an embodiment, a disable the monitoring application setting may allow a user to stop the monitoring activity of the computer device. In an embodiment, with the selection of this setting the user may be able to set the amount of time the monitoring application may be disabled and the action to be taken when that time period is complete. For example, the user may select the disable monitoring application setting and set the amount of time of 15 minutes; when the 15 minutes is over the action may be to restart the monitoring application. In an embodiment, this setting may allow the user to temporarily allow a user or third party to execute an interaction that may be considered inappropriate to the configuration settings without having to change the configuration of the computer device. For example, the user may disable the monitoring application to allow an inappropriate software application to run for a set time period, or to access websites that contain profiles or keywords that would otherwise lead to their interdiction. This “disable” feature may be used to allow a market researcher to investigate a subject such as erectile dysfunction online, for example, recognizing that the researcher may need to access websites that contain keywords or other indices that generally trigger the blocking function.

Referring to FIG. 2, an embodiment of the popup window 200 displaying more detail of inappropriate interactions is shown. In an embodiment, the pop-up window 200 may contain a table 202 of the software applications used and corresponding information in an historical format. In an embodiment, if there was inappropriate interaction, the entry in the table may be highlighted red, more detailed information may appear in the pop-up window 200 when the red entry is double clicked, there may be a table of the inappropriate interaction aggregated in accordance with user criteria contained in the configuration data tables or the like. In an embodiment, the table 202 may contain a plurality of columns that may include the activity 204, application 208, usage 210, user 212, or other functions such as a monitoring application, computer identification, configuration setting taking the action, and the like.

In an embodiment, the plurality of table 202 columns may have sorting objects that may allow any the sorting of the columns. In an embodiment, when one of the columns are sorted the information from the other columns may also be sorted to maintain the information relationship.

In an embodiment, the application listing 208 in the table 202 may list the applications in the order of user activity, aggregated by similar applications, aggregated by a user configuration setting, and the like. In an embodiment, the application name displayed in the application listing 208 may be the application executable name, the human readable name, or the like.

In an embodiment, an interaction listing in the table 202 may list the application interaction by a third party such as the type of interaction, the user performing the interaction, the configuration setting associated with the interaction, and the like.

In an embodiment, an action taken listing in the table 202 may list the actions taken by the monitoring application as a result of an interaction. In an embodiment, an action taken listing may list the number of times the application was blocked, the application time limit, access attempts for a blocked application, the amount of time an application was used for a time period, and the like.

In an embodiment, more detail may be accessible by clicking on a given instance, and may allow a user to select one of the listed interactions in the table 202 to request more detailed information about a certain inappropriate interaction. The more information may be computer machine information, interaction device (e.g. keyboard or mouse), time stamps, or the like.

In an embodiment, there may be other function buttons accessible on the pop-up window 200, such as a return to calendar button, a print report button, an error report button, and the like.

In an embodiment, an export report button may be used to export the report of another application such as spreadsheet application, word processor, presentation application, or the like to allow the user to do further analysis of the information.

In an embodiment, a return to main screen 100 button may return the user to the main screen 100 as described in FIG. 1. In an embodiment, the user may be able to switch between the main screen 100 and the popup window 200 to make changes to the monitoring application configuration settings 112. In an embodiment, the user may be able to display the popup window 200 over the main window 100 and also make changes to the configuration settings 1 12. In an embodiment, after making a change to the configuration settings 112, the table 202 listing may indicate if the inappropriate interaction monitoring would be affected. This interaction with the popup window 200 and the main window 100 may allow the user to modify the configuration settings 112 to monitor the application as required for a particular computer, user, third party, or the like.

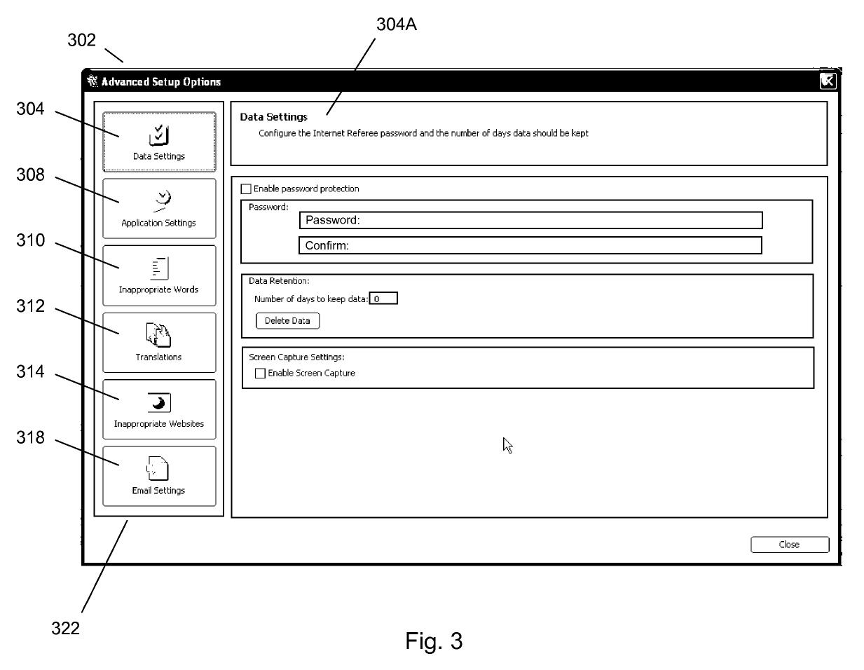

Referring to FIG. 3, an embodiment of a GUI that may appear when a user selects the advanced setup options 114 configuration button from the main screen 100 is shown. This advanced options screen 302 may include further information on data settings 304, application settings 308, inappropriate words 310, translations 312, inappropriate websites 314, e-mail settings 318, or the like. In embodiments, any of the screens associated with functions that are a part of the options selection window 322 may appear when a user selects the advanced setup options 114 configuration button, including a preference associated with a user selection, a preset selection, based on last use, or the like. In embodiments, the options selection window 322 may be shown whenever the user is in the advanced setup options screen 302, within any of the functions provided in the options selection window 322. The data which the user enters through these functions may allow the user to add/modify website names or URLs, translate machine executable names of programs into plain English names, designate additional inappropriate content words, add instant messaging translation names (i.e. plain English translations of internet jargon or slang), set email options, or the like. This data may be stored in data tables such as a websites checking table, an exclude programs table, a block programs table, a time limited programs table, an inappropriate content table, and the like.

Referring again to FIG. 3, the screen detailing the information available through the data settings button 304 is shown, as indicated by the data settings 304A header at the top of the page. Information available through the data settings 304 screen may include the ability to configure password settings and to set the number of days that data will be kept. Other functions that may be associated with the data settings 304 screen may include the ability to delete data, enable screen capture, password enable, access control, data record options, and the like.

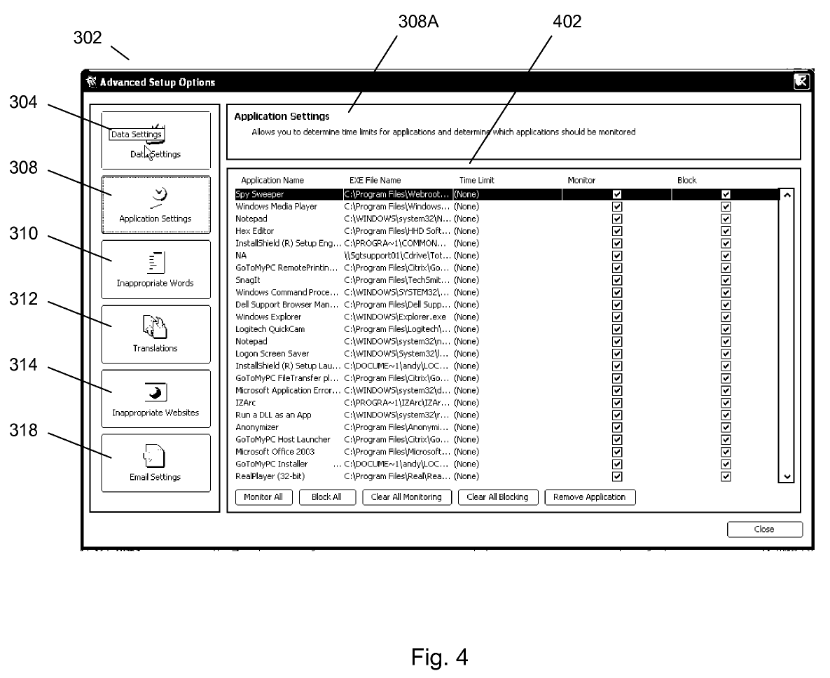

Referring to FIG. 4, the screen detailing the information available through the application settings button 308 is shown, as indicated by the applications settings 308A header at the top of the page. The application settings 308 screen may present an applications data table 402 that allows a user to determine the time limits for applications and may allow control over which applications should be monitored. The applications data table 402 may provide a plurality of information for application running, such as the application name, the executing file name, the time limit, control over whether the application is monitored, and the like. In embodiments, the applications data table 402 may be automatically filled via automatically reading the application name. In addition, the applications data table 402 may contain control functions in association with the table, such as to monitor all applications, block all applications, clear all monitoring, clear all blocking, remove an application, add a new application, or the like. In embodiments, new applications may be visually indicated, such as by color, by a different font characteristic, by its position in the list, or the like.

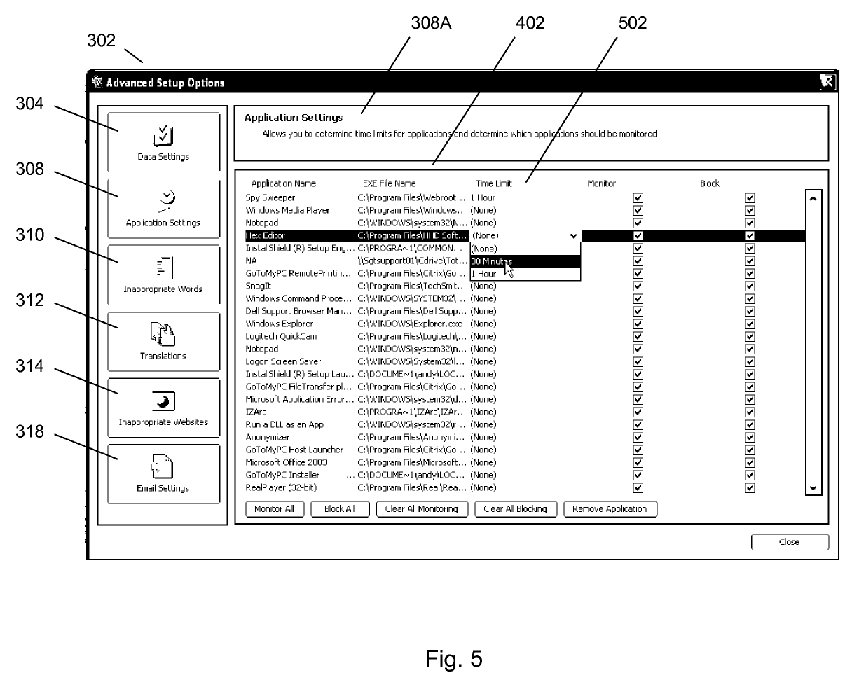

In embodiments, the user may select an application name from the applications data table 402 in order to modify the control parameters for the application. For instance, if the user wants to monitor the application for inappropriate content, the user may check the monitor box within the applications data table 402. If the user wanted to monitor and block inappropriate content, the user may check both the monitor and block boxes within the applications data table 402. If the user wants to block on time limit, the user may set the time limit with a pull down and set the desired time limit. FIG. 5 shows the detail that may be made available through the time limit 502 column of the applications data table 402, where different time limits may be available for selection, such as one hour, a half hour, one day, none, or the like. In embodiments, the user may be asked to confirm a change to the applications data table 402, asked to provide a password for the change, or the like.

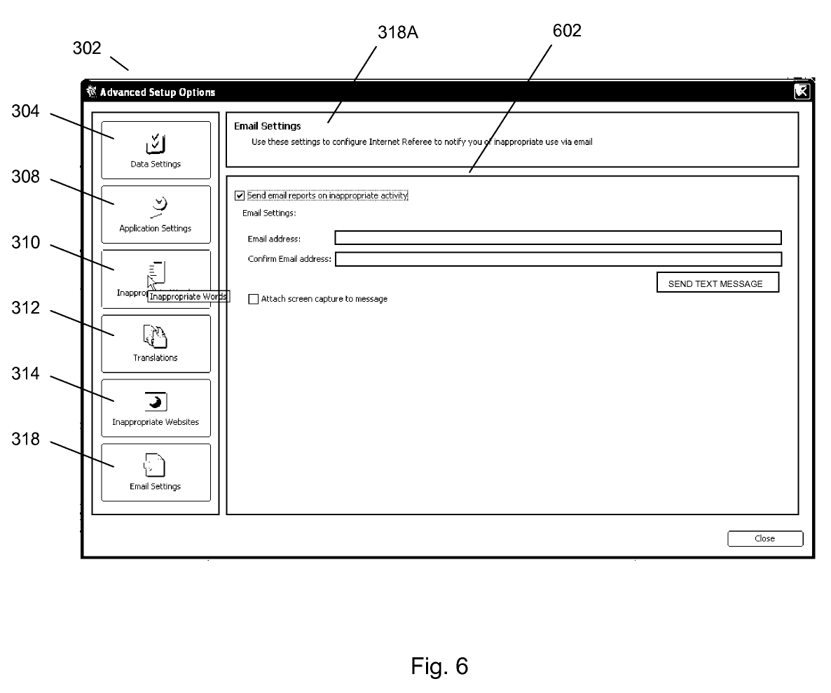

Referring to FIG. 6, the screen detailing the information available through the email settings button 318 is shown, as indicated by the email settings 318A header at the top of the page. The email settings 318 screen may present settings to configure the system to notify the user of inappropriate use via email. The email settings area 602 of the screen may allow a user to set whether or not they want to be notified by email or not, the email address to send reporting to, whether to attach screen captures to the email message or not, and the like. The data that the user enters through this interface may allow the user to designate one or more e-mail addresses to which various activity statistics and/or time period statistics may be sent. The time period statistics may also be viewable in the main screen 100. The designated e-mail addresses may receive e-mail containing alerts and notices relating to use, interaction or other activity on a designated computer device. In embodiments, the user may preset the content and timing information of the alerts and notices.

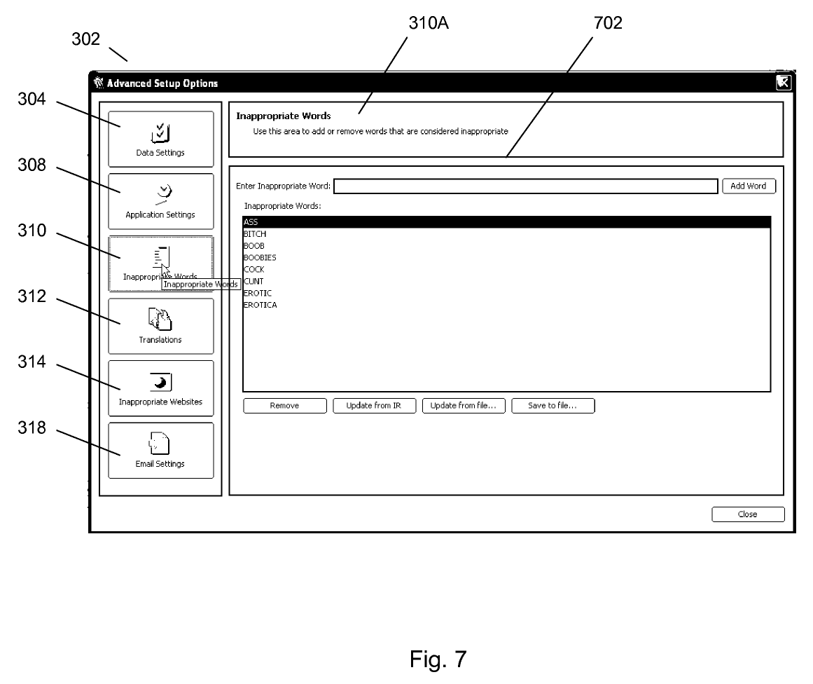

Referring to FIG. 7, the screen detailing the information available through the inappropriate words button 310 is shown, as indicated by the inappropriate words 310A header at the top of the page. The inappropriate words screen 310 may enable the user to add or remove words that the user considers inappropriate, as well as modify words to be included. The inappropriate words screen 310 may contain a list 702 of inappropriate words and the ability to add, remove, or edit words from the list 702. In embodiments, lists 702 may be supplied from a server over the internet or from a local area network, from a file kept on the user's computer, saved to a file, or the like, and the user may be asked to verify the word removal or modification, asked for a password, or the like, before executing the action. In an embodiment, the set of downloaded inappropriate words may be compared to the existing words and only new words may be added. In an embodiment, the user may be prompted to confirm the addition of new words into the inappropriate words list 702. In an embodiment, the user confirmation choices may be save all, don't save all, don't save this one, save this one, replace all, or the like.

In an embodiment, a translations function may perform translations, edit translations, remove translations, add translations from the Internet, or the like. In an embodiment, these functions may be used to manage a list of translations that may be monitored by the monitoring application. In an embodiment, the user may add and edit the translations. In an embodiment, a translation may be removed from the list. In an embodiment, the user may be asked to verify the translation removal, ask for the users password, or the like before removing the translations.

In an embodiment, the translations may be used to provide users with plain language translations for the slang, jargon, abbreviations, and the like used in IM messages. In an embodiment, the plain language translations may be in the form of sentences, paragraphs, documents, or the like. The plain language translations may provide the user with the appropriate meaning of an IM message that uses slang, jargon, abbreviations, and the like. The plain language translation may provide with a clearer meaning of the IM text, therefore allowing a user to take appropriate action based on the true meaning of the IM message.

In an embodiment, translations may be downloaded from an Internet website for use with the monitoring application. In an embodiment, the set of translations may be compared to the existing translations and only new translations may be added. In an embodiment, the user may be prompted to confirm the addition of new translations. In an embodiment, the user confirmation choices may be save all, don't save all, don't save this one, save this one, replace all, or the like.

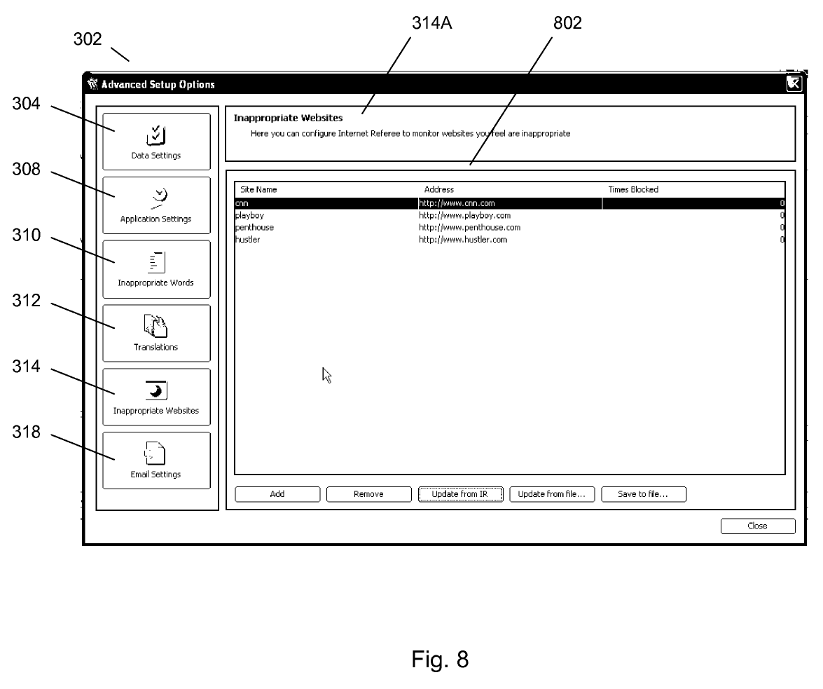

Referring to FIG. 8, the screen detailing the information available through the inappropriate websites button 314 is shown, as indicated by the inappropriate websites 314A header at the top of the page. The inappropriate websites 314 screen may present settings to configure the system to monitor websites that the user feels are inappropriate. The inappropriate websites 314 screen may include a listing 802 of information associated with websites that the user considers inappropriate, such as the site's name, the web address of the site, the number of times the site has been blocked, and the like. The user may be able to modify the listing 802 of inappropriate websites, such as by adding new sites to the list 802, removing sites from the list 802, updating the list 802 from a central server for the system, updating the list 802 from a local file, or the like. In an embodiment, a set of inappropriate URLs may be downloaded from an Internet website for use with the monitoring application. In an embodiment, the set of inappropriate URLs may be compared to the existing URLs and only new URLs may be added. In an embodiment, the user may be prompted to confirm the addition of new URLs into the list 802. In an embodiment, the user confirmation choices may be save all, don't save all, don't save this one, save this one, replace all, or the like.

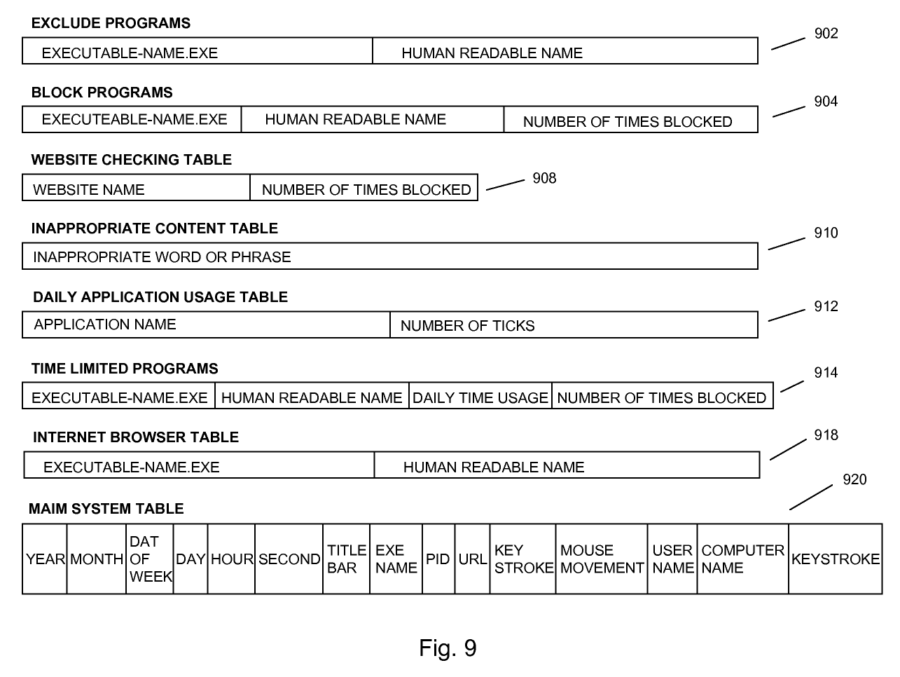

Referring to FIG. 9, an embodiment of the file layouts used to configure and collect designated computer device interactions is shown. The file type may be a file, a group of files, a database, an SQL database, a relational database, a table, an ASCII table, a flat file, or the like. A plurality of files may be used to configure, track and collect designated computer device interactions, for example an exclude programs table 902, a block programs table 904, a website checking table908, an inappropriate content table 910, a daily application usage table 912, a time limited programs table 914, an internet browser table 918, a main system table 920, and the like. It should be understood that while the file descriptions in FIG. 9 are shown as one record that there may be a plurality of records for any of these files, or multiple files containing the relevant records.

In an embodiment, the Exclude Programs table 902 may be filled in by the user entering information via the GUI, containing for example the machine executable names for programs that are not to be checked by the invention for inappropriate content. In an embodiment, this table may contain fields for the software application executable file name, a software application name, and other descriptive fields. For example, a record may contain the executable name “word.exe” and the application name may be “Word”. In an embodiment, software applications in this database may be excluded from any monitoring activity.

The Block Program table 904 may be filled in by the user entering information to the GUI or by file download (e.g. by updates provided to user) to contain the machine executable names for programs that are to be checked for inappropriate content and, if true, then blocked from executing. In embodiments, the Block Program table 904 may contain machine executable names for programs that are to be blocked from executing under all circumstances. In an embodiment, the Block Program table 904 may contain fields such as a software application executable name, a software application name, number of times the software application may have been blocked, and the like. For example, a record may contain the executable name “word.exe” and the application name may be “Word”. The field for the number of times blocked may be maintained by the monitoring application whenever a user attempts to run the executable software application. In an embodiment, when a new record is entered the number of times blocked field may default to zero.

The Websites Checking table 908 may be filled in by the user entering information to the GUI or by file download (e.g. by updates provided to user) to contain prohibited website names for sites accessed by Internet browser programs. In embodiments, the website may be checked for objectionable content, with access blocked if such content is found. In embodiments, a website or category of websites may be blocked under all circumstances. In an embodiment, the Websites Checking table 908 may contain fields such as website name, number of times blocked, or other informational fields. In an embodiment, the website name may be the banner name of a website, title of the website, URL of the website, or other website identifier. The field for the number of times blocked may be maintained by the monitoring application whenever an inappropriate website is attempted to be accessed. In an embodiment, when a new record is entered the number of times blocked field may default to zero. In an embodiment, the surveillance of website activity may be supplemented by recognition of keystrokes typed by the user while on a website as well as by text which may appear on the banner of a website.

The Inappropriate Content table 910 may be filled by the user entering information to the GUI or by file download (e.g. by updates provided to user). The information in this table may contain instant messaging slang or jargon, a translation of slang or jargon used by instant messaging applications, or the like. In an embodiment, the table information may be used to check for inappropriate words, phrases, slang, lingo, or the like contained in an instant message dialogue. If such inappropriate content is detected, the consequence may be program blocking via operation of the Block Programs table 902 or other action as set by the user through selection of options when inappropriate content is selected. In an embodiment, this table may include a field with a translation of any slang, jargon, abbreviation, or other the like. The translation field may be used in reporting the inappropriate interactions that use various slang or jargon to minimize any misunderstanding of the reported inappropriate interactions. In an embodiment, when an inappropriate interaction is detected in an IM dialogue, the monitoring application may provide the user with a translation of the IM dialogue. The provided dialogue may allow the user to understand the dialogue and to minimize misunderstanding that may arise from a user not understanding the IM slang or jargon. In an embodiment, a user may be able to enter a slang or jargon translation, download slang or jargon translations, over write a translation provided by a downloaded file, or the like.

The Daily Application Usage table 912 may be filled with software application usage time amounts (number of ticks) for the current time period and may be used to compile application usage data to be aggregated on various usage data and summary tables. In an embodiment, this table may contain fields such as application name, number of ticks (e.g. time increments), and the like. In an embodiment, this table may be maintained by the monitoring application without the user or third party aware of the data collection. In an embodiment, a user may be able to enter a plurality of software applications that may have time usage data gathered. In an embodiment, every time a software application from the table is active, the monitoring application may gather the amount of time the software application is running. In an embodiment, the monitoring application may be able to monitor a plurality of software applications simultaneously.

The Time Limited programs table 914 may be filled by the user entering information to the GUI to contain the machine executable names for programs that are to be time limited (according to pre-set time limits), whereby the listed program(s) may be blocked from executing if the pre-set time limit for use is exceeded. In an embodiment, this table may contain fields such as executable name, software application name, daily time usage, number of times blocked, and the like. The software application executable name may be the executable name such as “word.exe” and may have an associated software application name such as “Word”. In an embodiment, the daily time usage field may define the amount of time that the software application may be used per day. In an embodiment, the number of times blocked may track the number of times the software application may be blocked because the defined time for the day has been exceeded. In an embodiment, the number of times blocked field may be reset to zero each day, keep a running total, maintain a running total for a user defined amount of time, or the like.

The Internet Browser table 918 may be filled by the user using the GUI or by file download (e.g. by updates provided to user), and may contain the name of Internet browser software applications (e.g. Internet Explorer) that may be used on the computer device. In an embodiment, this table may contain fields such as software application executable name, software application name, and the like. For example, the executable name may be “iexplore.exe” and the associated software application name may be “Internet Explorer”. In an embodiment, there may be a field to define the amount of time per time period the Internet browser may be used per time period. There also may be a field to track the number of times the Internet browser was blocked because the amount of time for the Internet browser had been exceeded.

The main system table 920 may be maintained by the monitoring application and may contain fields for gathering information about the computer device, software applications, time of day, website information, key stroke information, mouse information, the user, and the like whenever an inappropriate interaction occurs. The main system table 920 may contain fields for gathering information related to inappropriate use of the designated computer device use. In an embodiment, for every detected inappropriate use or interaction of the designated computer device the monitoring application may gather the information in the main system table.

In an embodiment, for each new inappropriate use or interaction the monitoring application may create a new record to gather the data related to the inappropriate interaction. In an embodiment, for continuing inappropriate uses or interactions, the monitoring application may update an existing record initially created for the first inappropriate interaction. For example, a new record may be created in the main system table 920 the first time a user attempts to use an inappropriate software application. If the user attempts to use the same inappropriate software application again, the monitoring application may locate the initial record and update it. In another embodiment, the monitoring application may always create a new record for each inappropriate interaction. In this case, the individual records in the main system table 708 may be aggregated by a reporting facility when a user requests data for a particular inappropriate interaction.

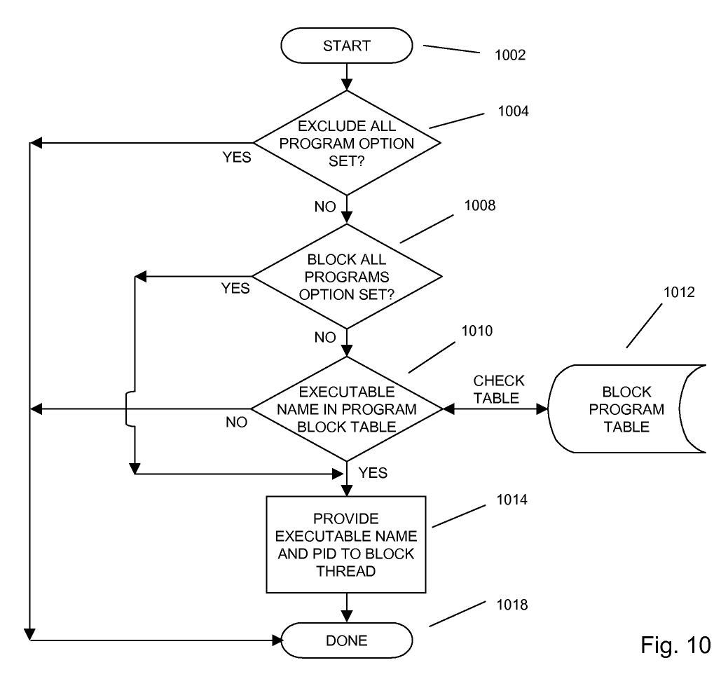

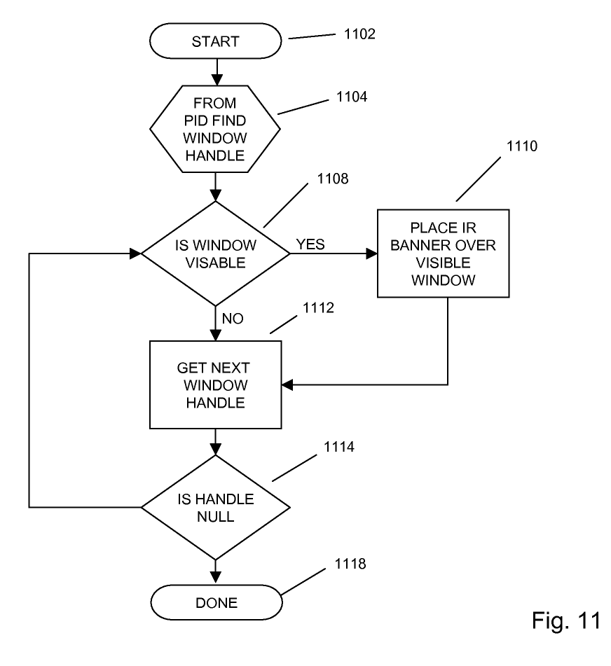

Referring to FIG. 10, an embodiment of a schematic and flow diagram is illustrated showing the steps that may be used for identifying computer device software applications for blocking. The start step 1002 initiates a check sequence in accordance with user configuration settings and monitoring and blocking instructions. If the Exclude All Programs option 1004 is selected in connection with monitoring, then the system proceeds to done 1018, resulting in no software applications being blocked. If the Exclude All Programs option 1004 is not selected, then the system checks whether the Block All Programs option 1008 has been selected. If the Block All Programs option 1008 has been selected, then the system provides all of the software application executable names and program ID (PID) to the block thread 1014, as is further discussed in FIG. 11. After the software application executable names and PID are provided to the blocking thread 1014 the sequence is complete 1018. If the Block All Programs option 1008 has not been selected, then the system performs a check of the machine executable name of the software application 1010 in the Program Block table 1012. If the software application does not reside in the Program Block table 1012, then the sequence proceeds to done 1018 and the software application is not blocked. If the software application does reside in the Program Block table 1012, then the program's executable name and PID is provided to the block thread 1014.

Referring to FIG. 11, an embodiment of a schematic and flow diagram illustrating the steps used for blocking programs is shown. The start step 1102 may correlate to providing the software application executable name and PID of a prohibited program to the block thread 1014. A window handle 1104 that may be a unique identifier of a defined window may be obtained using the PID. If the software application window to be blocked is visible 1108, the monitoring application may place a special banner over the visible window of the blocked or prohibited program 1110. The monitoring application may obtain the next window handle 1112 that may be visible. If that window handle is determined to be a null 906, the blocking sequence proceeds to completion 1118. However, if the next window handle is not a null 1114 and is visible 1108, a banner is placed over the visible window 1110. The monitoring application may repeat this check sequence with each subsequent window handle until there are no more visible windows, whereupon the sequence proceeds to complete 1118.

An embodiment of a banner used to block 1110 a visible window is shown in FIG. 12. The immediate banner blocking 1110 may provide an immediate feedback of prohibited computer device interaction to the individual using the designated computer device. This feedback may take place even if the prohibited interaction is only attempted or is not completed. In an embodiment, one who has access to the desktop of the designated computer device may be visually or aurally alerted to the inappropriate computer device interaction.

Referring to FIG. 10, an embodiment of a banner 1202 over an inappropriate software application 1204 is shown. In an embodiment, when inappropriate interactions are detected by the monitoring application, the monitoring application may display a banner screen 1202 over the inappropriate application 1204. In an embodiment, the banner 1202 may be placed over the software application 1204 in a way to prevent further interaction with the inappropriate software application 1204. In an embodiment, the inappropriate software application may be minimized; the banner 1202 may still block interaction with the minimized application. For example, when the minimized inappropriate application 1204 is maximized or otherwise visible on the screen, the banner may block access to the visible software application 1204. In an embodiment, this may be an effective method of preventing inappropriate interactions with an application without blocking access to the application or other applications. In an embodiment, the banner 1202 may have been activated because of inappropriate use of an application, inappropriate use of a website, inappropriate words, an exceeded time limit for a software application, or other conflict with a monitoring application configuration setting. In an embodiment, only the user may be able to remove the banner 1202 from blocking the software application 1204. In an embodiment, the banner window may be modal to prevent interaction with inappropriate software application 1204, cover the entire screen, move with the computer device inputs (e.g. mouse or keyboard) to prevent access to the software application 1204, or the like.

In an embodiment, the banner 1202 may be over a first inappropriate application 1204 but may still allow access to a second appropriate software application. For example, an inappropriate website may be accessed that may result in the browser application having a banner 1202 placed over it to prevent further interaction while a word processor application, that is an appropriate interaction, may remain accessible on the same computer device. In this manner, inappropriate software applications may be blocked from further interaction but allowed software applications may continue to have unblocked interaction.

In embodiments an update process may allow generation of updates relevant to monitoring computer activities, including updates based on translated IM slang language, content triggers for web searching, or customized modules for table adjustments when the program is being deployed for certain uses.

The systems and methods described herein may be better understood by these examples that follow, which examples are intended to be illustrative only and not to be limiting.

As an example, the systems and methods described herein may be used to monitor and control the usage of designated computer devices in the home. The ability to block selected programs, limit time spent on certain applications, and monitor usage may be ideal for parents attempting to control inappropriate usage of home computers by young children and adolescents. In such a case, the user may be a parent or parents who could set configurations according to the programs they wanted their children to use and the time periods to which they wanted to restrict use. They could further protect their children from cyber stalking and engaging in inappropriate communications by monitoring e-mail and IM communications and adding certain words such as sex or sexually related expletives to their inappropriate content table. The ability to translate IM lingo to plain English may be particularly useful for ensuring that they understood the potentially problematic communications of teenagers and young children accessing instant messages from third parties. The monitoring application may translate the “slang” or lingo of IM communications by providing a translation of an IM dialogue into standard language syntax to make the IM dialogue meaning clear to avoid misunderstandings of the IM dialogue by the parent. The blocking procedure, which preserves the blocked application with a block banner, may enhance parental ability to monitor use by enabling a parent to more readily determine if children had been attempting to engage in prohibited computer device activities. The alerting features of these systems and methods may facilitate remote monitoring and control of designated computer systems in the home by providing information to parents about their children's computer usage. A parent in another part of the house may be alerted to an inappropriate use of a designated computer by an email, an instant message, or an auditory or visual signal displayed on a computer terminal or broadcast on a web-enabled multimedia screen.

As another example, these systems and methods are suitable for use in an office or a business environment. Users in this case may be employers or their agents, while the third parties using the computers may be their employees, visitors, or other individuals using the businesses computers for specific permitted purposes. The applications outlined above in connection with the home may be adapted to the work environment. For example, monitoring applications may allow an employer to see how employees use their computer devices during business hours, so that directives, disciplinary action or training may be implemented accordingly. Alternatively, the monitoring applications may allow an employer to gain insight into time management issues, with the goal of improving employee productivity. Blocking the functionality of certain categories of programs may improve employee compliance with the business usage policies, and may also reduce the company's potential liability for unauthorized actions by their employees, such as pirating and cyber stalking. The ability to monitor usage and block software application usage may also increase company security by limiting improper hacking or snooping activities, and by reducing risk of damage to proprietary data from corrupted or infected files that employees download from external sources. The ability to selectively prevent employees from using software applications such as personal email software, instant message software, banking software, commercial or transactional software, and personal money management software in the workplace may enhance productivity while preventing the employee from engaging in activities that may unwittingly make his or her confidential information accessible to an employer or his/her agents.

In a business environment the monitoring application may also be used in the networked environment of larger businesses. In an embodiment the monitoring application may be installed on a server and administered by a network administrator and/or administrative head. The configuration settings may be set by company policy and installed company wide to monitor use of any software available on the company's server. In another embodiment, the monitoring software may be installed on individual client computer devices and the individual monitor application databases may be aggregated by a server application for at least one of the client computer devices. In a network environment, the network administrator may be able to control the configuration settings that the individual client computer devices may be used for determining inappropriate computer device interaction. In an embodiment, the individual users on the client computers may be able to adjust some or all of the configure settings for their individual computer device. Depending upon the company's goals in monitoring and controlling designated computer use, the systems and methods may operate silently in the background, or they may provide more or less conspicuous alerts to employees whose computer use is inappropriate. These systems and methods may focus on collecting data, blocking certain activities, or any combination of monitoring functions and controlling functions, consistent with the company's business objectives.

Aspects of the present invention may be applied in a number of sectors besides home or office environments, including but not limited to: correctional facility, shelter, elderly home, hostel, hotel, military base, government agency, customer service center, academic testing center, educational facility, public internet or computer café, business or conference center, public computer kiosk, business computer kiosk (i.e. computer terminal in a retail store for ordering or customer service), library, or the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method of monitoring a computer device, comprising:
indicating on a computer device configuration settings used to monitor a user interaction, the configuration settings being saved on a storage device;
comparing the user interaction to the configuration settings;
identifying conflicts between the user interaction and the configuration settings, the conflicts being saved to a storage device; and
displaying to a calendar style graphic user interface (GUI), an indicator of at least one conflict.

2-7. (canceled)

8. The method of monitoring a computer device of claim 1, wherein the configuration settings define a user-inappropriate interaction.

9-16. (canceled)

17. The method of monitoring a computer device of claim 1, wherein the configuration settings are to set program time limits.

18. The method of monitoring a computer device of claim 1, wherein the configuration settings set an email option.

19-21. (canceled)

22. The method of monitoring a computer device of claim 1, wherein the configuration settings set instant message options.

23-24. (canceled)

25. The method of monitoring a computer device of claim 1, wherein the configuration settings are used to display a flash screen for inappropriate behavior.

26-27. (canceled)

28. The method of monitoring a computer device of claim 1, wherein the configuration settings block a software application from executing.

29. The method of monitoring a computer device of claim 1, wherein the configuration settings are entered by a user.

30. The method of monitoring a computer device of claim 1, wherein the configuration settings are downloaded from a network.

31-33. (canceled)

34. The method of monitoring a computer device of claim 1, wherein the configuration settings are a combination of user entered settings and downloaded settings.

35. The method of monitoring a computer device of claim 1, wherein a user interaction is selected from a group including running a software application, sending an email, sending an instant message, browsing a network, browsing the internet, browsing a web page, and playing a computer game.

36-52. (canceled)

53. The method of monitoring a computer device of claim 1, wherein the time period is selected from a list including an hour, a day, a week, a month, a fiscal quarter, a calendar quarter, a fiscal year, and a calendar year.

54-55. (canceled)

56. The method of monitoring a computer device of claim 1, wherein the GUI includes a display of statistics for a particular computer device.

57. The method of monitoring a computer device of claim 1, wherein the GUI includes a display of inappropriate interactions for a selected time period.

58-66. (canceled)

67. The method of monitoring a computer device of claim 1, wherein the computer device is blocked from executing a software application.

68. (canceled)

69. The method of monitoring a computer device of claim 1, wherein the computer device is blocked from executing a particular web browser.

70. The method of monitoring a computer device of claim 1, wherein the computer device is blocked from using configuration defined content.

71. The method of monitoring a computer device of claim 1, wherein the computer device is blocked from operating after a certain amount of time.

72. The method of monitoring a computer device of claim 1, wherein identifying the conflict further comprises an instantaneous feedback.

73-95. (canceled)

96. A system of monitoring a computer device, comprising:
a computer device with configuration settings used to monitor a user interaction, the configuration settings being saved on a storage device;
the user interaction compared to the configuration settings;
conflicts identified between the user interaction and the configuration settings, the conflicts being saved to a storage device; and
a calendar style graphic user interface (GUI), an indicator of at least one conflict.

97-190. (canceled)
